(19) United States
(12) Patent Application Publication
(10) Pub. No.: US 2025/0356129 A1
(43) Pub. Date: Nov. 20, 2025

(54) Requirement Extraction from Documentation

(71) Applicant: NATIONAL INSTRUMENTS CORPORATION, Austin, TX (US)

(72) Inventors: Stephen Thung, Norman, OK (US); Andrew Philip Dove, Austin, TX (US); Sebastien Savard-Rosas, Austin, TX (US)

(21) Appl. No.: 19/210,865

(22) Filed: May 16, 2025

Related U.S. Application Data
(60) Provisional application No. 63/648,768, filed on May 17, 2024.

(51) Int. Cl. G06F 40/295; G06F 11/07; G06F 16/334; G06F 40/226

(52) U.S. Cl. CPC G06F 40/295; G06F 11/0769; G06F 16/3347; G06F 40/226

(57) ABSTRACT

Apparatuses, systems, and methods for extracting structured specification requirements from specification documents associated with a device under test (DUT) can include generating one or more semantic units based on DUT specification documentation and performing a structured large language model (LLM) call to generate test requirements for the DUT based on the generated one or more semantic units and an entity extraction task. The entity extraction task can be defined via a system prompt command that is responsive to presenting an end user with a system prompt for the entity extraction task. The one or more semantic units can be generated via portioning of DUT specification documentation.

### PRIORITY CLAIM

This application claims benefit of priority to provisional application No. 63/648,768 entitled “Requirement Extraction from Documentation”, filed on May 17, 2024, whose disclosure is hereby incorporated by reference in its entirety as though fully and completely set forth herein.

### TECHNICAL FIELD

The invention relates to test process development, and more particularly to apparatuses, systems, and methods for generative Artificial Intelligence (AI) assisted test process development, e.g., using a generative AI based system to extract test requirements from documentation associated with a device under test (DUT).

### DESCRIPTION OF THE RELATED ART

Currently, there are a variety of tools to support a test engineer in test process development when given a specification of a DUT. For example, there are tools to aid a test engineer in the front-end of life cycle of a test process, e.g., such as tools to match tests to instruments. Further, there are tools to aid a test engineer in the back-end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Therefore, improvements are desirable.

### SUMMARY

Embodiments described herein relate to computing systems, memory media, and methods for generative Artificial Intelligence (AI) assisted test process development, e.g., using a generative AI based system to extract test requirements from documentation associated with a device under test (DUT).

For example, methods described herein can be run piecewise (e.g., independently) and/or in conjunction to extract structured specification requirements from specification documents, e.g., associated with a DUT. As described herein, these methods can be applied to extract structured output of any format given a JavaScript Object Notation (JSON)-like model of a desired output. The documentation can take various formats such as word processing documents, Portable Document Format (PDF) documents, spreadsheets, presentation documents, three-dimensional (3D) models, two-dimensional (2D) models, images, videos, and/or other multimedia recordings, among other file types and/or formats. The documentation can be partitioned (e.g., chunked) into one or more semantic units that can be fed into a large language model (LLM) (e.g., via a structured LLM call). Outputs from the LLM can then be used to generate test requirements.

In some embodiments, a method for extracting structured specification requirements from specification documents associated with a DUT can include generating one or more semantic units based on DUT specification documentation and performing a structured large language model (LLM) call to generate test requirements for the DUT based on the generated one or more semantic units and an entity extraction task. The entity extraction task can be defined via a system prompt command that is responsive to presenting an end user with a system prompt for the entity extraction task. The one or more semantic units can be generated via portioning of DUT specification documentation.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a test generation system, according to some embodiments.

FIGS. 4 and 5 illustrate block diagrams of examples of processes for extracting structured specification requirements (e.g., structured object/object model) from specification documents associated with a DUT, according to some embodiments.

FIG. 6 illustrates a block diagram of an example of a process for filtering requirement entities outputted from a structured LLM call, according to some embodiments.

FIG. 7 illustrates a block diagram of an example of a process for clustering requirement entities outputted from a structured LLM call, according to some embodiments.

FIG. 8 illustrates a block diagram of an example of a process for consolidating clusters of similar requirement entities outputted from a structured LLM call, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
AI: Artificial Intelligence
DUT: Device Under Test
UUT: Unit Under Test
VI: Virtual Instrument
GUI: Graphical User Interface
LLM: Large Language Model
JSON: JavaScript Object Notation

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which can be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. Can also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. Can also be referred to as a Virtual Instrument (VI).

Graphical User Interface—this term is intended to have the full breadth of its ordinary meaning. The term “graphical user interface” is often abbreviated to “GUI”. A GUI can comprise only one or more input GUI elements, only one or more output GUI elements, or both input and output GUI elements. Can also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI can comprise a single window, panel, or dialog box having one or more GUI Elements, or can comprise a plurality of individual GUI Elements (or individual windows each having one or more GUI Elements), wherein the individual GUI Elements or windows can optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

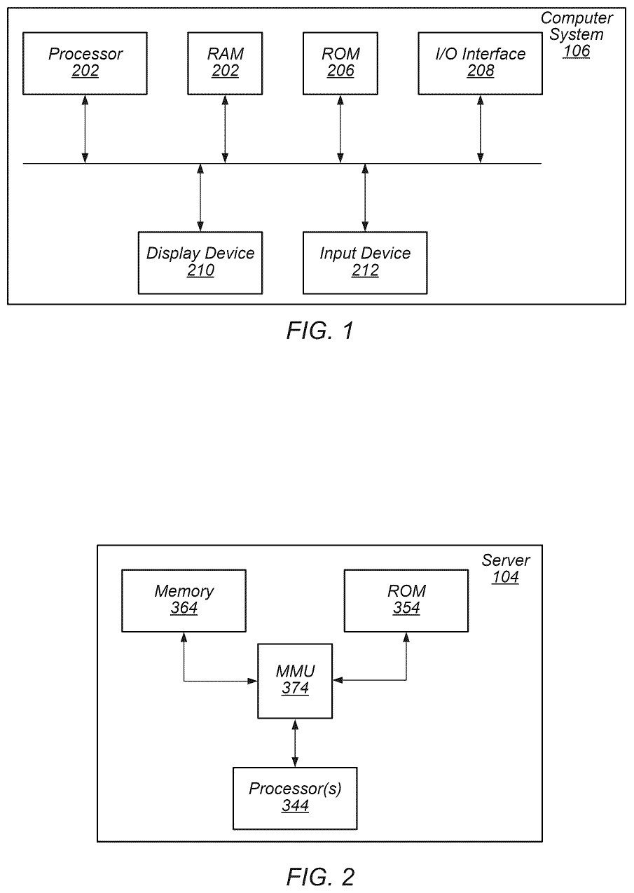

### FIG. 1: Computer System

FIG. 1 illustrates a computer system 106 that can include a processor 202, random access memory (RAM) 204, nonvolatile memory 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user interface elements for receiving user input and a display device for presenting output. For example, the user interface elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can access via a radio access network, such as a 5G New Radio (5G NR) radio access network. In some embodiments, the server 104 can be accessed via a local area network (LAN), e.g., via an ethernet and/or Wi-Fi connection.

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

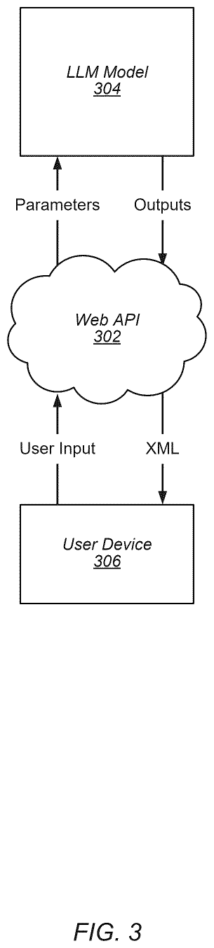

### FIG. 3: Test Generation System

FIG. 3 illustrates an example of a system supporting a test generation system, according to some embodiments. As shown, the system can include a user device 306, e.g., which can be a computer system 106 that provides an interface with a LLM model 304 (e.g., which can be hosted on a server, such as server 104) via a web Application Programming Interface (API) 302. In at least some instances, the LLM model 304 can be one or more models 304 (e.g., one or more artificial intelligence models). The interface can allow the LLM model 304 to interact with (e.g., communicate with) local hardware either on the user device 306 and/or in communication with the user device 306. In addition, the interface can allow the LLM model 304 to interact with local software resources (e.g., such as programming platforms (e.g., LabVIEW™, Python, MeasurementLink, C++, MATLAB™, and so forth). Thus, as shown, a user can interact with the LLM model 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including information regarding available hardware and/or software resources to the web API 302. The web API 302 can convert the user inputs to LLM model parameters and/or the web API 302 can generate LLM model parameters based on the user inputs. The LLM model parameters can be used by the LLM model 304 to generate and/or produce model outputs that are returned to the web API 302. The web API 302 can then convert the model outputs to Extensible Markup Language (XML) and/or generate XML based on the model outputs. For example, the model outputs can include programming code (e.g., such as graphical programming code) that can be converted (e.g., serialized) to Large Language Model (LLM) optimized XML, JavaScript Object Notation (JSON), and/or a Domain Specific Language (DSL). The XML can then be delivered to the user device 306 as natural language output to an end user. In this manner, the LLM model 304 can interact with the end user to generate and/extract test requirements from documentation associated with a device under test (DUT). Note that the LLM model 304 can be trained to query end users using a plurality of prompts based on user input. Further, the LLM model 304 can be trained to generate graphical programs based on consuming graphical programs, e.g., the LLM model 304 can be trained using thousands of graphical programs. Note further, that aspects of the LLM model 304 can include a user interface executing on the user device 306 as well as background software to discover and maintain hardware information as well as to discover and maintain connections with local applications, the web API 302 to allow the user device 306 to interact with the LLM model 304, and the LLM model 304 that can be executing on a server remote from the user (e.g., the LLM model 304 can be cloud based).

### Test Requirement Generation

Currently, a test engineer may need to work/interact with many, disparate software systems to leverage various tools to develop a test process for a device under test (DUT). Thus, the current test engineer needs to not only understand the DUT to design the test process, but additionally be versed in a vast array of tools. In various aspects of development of the test process, the test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each of these roles/tools require independent expertise and resources, leading to high overhead costs in time, training, and expertise develop. These high overhead costs can then extend time to market for particular products. Therefore, improvements are desirable.

Embodiments described herein provide systems, methods, and mechanisms to extract test requirements for a device under test (DUT) from documentation associated with the DUT, e.g., via leveraging a large language model (LLM) on partitioned segments of the documentation. For example, methods for structured object generation can be used to extract a structured object (e.g., an object model serialized in a string format (e.g., such as JSON)) from short and long-form documentation, e.g. instead of being limited to extracting specific types of entities (e.g., requirement entities). As another example, methods for multi-modal inputs can support various modalities of input, e.g., such as plaintext, tabular data, and/or multimedia (e.g., graphs, diagrams, images, videos, audio files, and so forth). As a further example, methods for object validation and refinement can incorporate object validation using various tools to ensure that generated objects (e.g., structured objects) conform to an expected structure and content and can allow for refinement and grouping of extracted entities through clustering and filtering. As yet another example, some methods can incorporate human-in-the-loop feedback, e.g., algorithms described herein can provide mechanisms for human intervention, e.g., to allow for review and correction of failed object extraction, which is essential for achieving high accuracy and confidence in the extracted entities. As described further herein, such an algorithm can be designed to extract any generalized structured object from short and long-form documentation. The only constraint is that an object model must be serializable in string format such that a large language model can reliably generate objects of this format.

In some instances, a collection of methods that can be run piecewise (e.g., independently) and/or in conjunction to extract structured specification requirements (e.g., a structured object or object model) from specification documents associated with a DUT. These methods can be applied to extract structured output of any format given a structured object (e.g., an object model serialized in a string format) of a desired output.

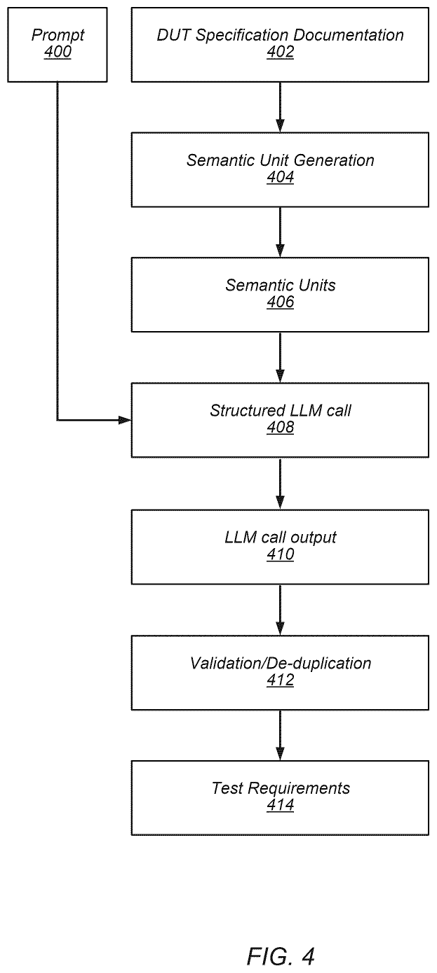

For example, FIG. 4 illustrates a block diagram of an example of a process for extracting structured specification requirements (e.g., structured object/object model) from specification documents associated with a DUT, according to some embodiments. The process shown in FIG. 4 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 400, a system prompt for an entity extraction task (e.g., the entity extraction task can be a structured object such as test requirements) can be received. In some instances, construction of the system prompt for the entity extraction task can include English instructions that provide initial instructions, guidelines in the entity extraction task, and/or definition of an object model/structured object that captures a structure and content of an object (e.g., object model) to be extracted (e.g., test requirements for the DUT). Note that schema that defines the structure and content of the object model can be used as output formatting instructions in a subsequent call to an LLM, such as LLM 304. Table 1 illustrates one possible example of a basic object model that can define an expected structure of a basic requirement entity to extract.

TABLE 1
Object Model

| | |
|---|---|
| 1. | class Requirement(BaseModel): |
| | category: str = Field( |
| 2. | description=“The classification of this requirement. Options are [‘HW |
| | Capability’,‘SW Capability’, ‘Documentation’, ‘Other’].” |
| 3. | ) |
| 4. | description: str = Field(description=“The description of the customer's |
| | requirement”) |
| 5. | |
| 6. | class ReqMetadata(BaseModel): |
| 7. | reduced: bool = False |
| 8. | source: str = “N/A” |
| 9. | title: str = “Untitled” |
| 10. | page: int = −1 |
| 11. | cluster: int = −1 |
| 12. | embedding: List[float] = [ ] |
| 13. | |
| 14. | class Requirements(BaseModel): |
| 15. | requirements: List[Requirement] = Field(description=“List of all |
| | Requirements.”) |
| 16. | |
| 17. | REQUIREMENT_PARSER = |
| | PydanticOutputParser(pydantic_object=Requirements) |

Note that individual semantic units as defined above can be used as relevant context from which to extract entities from, at least in some instances.

At 402, specification requirements documentation associated with a DUT can be loaded into memory. This documentation can take various forms, including, but not limited to, word processing documents, Portable Document Format (PDF) documents, spreadsheets, presentation documents, three-dimensional (3D) models, two-dimensional (2D) models, images, videos, and/or other multimedia recordings, among other file types and/or formats.

At 404, the specification requirements documentation (e.g., documentation) can be partitioned into various smaller semantic units that together encompass the specification requirements documents (e.g., via chunking). Note that such partitioning can extend beyond typical chunking methods as the partitioning collects and groups plaintext, tabular data, as well as various media (graphs, diagrams, images, videos, and the like) modalities into their respective semantic units (chunks). These respective semantic units can capture one or more whole elements to preserve coherence and completeness of concepts in the specification requirements documentation. In addition, metadata that captures information about the source and location of elements in a semantic unit can be recorded. Further, the semantics-based chunking described herein allows the specification requirements documentation to be partitioned into meaningful units that are relevant to the context and meaning of the text. For example, a chunk (and/or sematic unit) can be a paragraph that describes a specific feature or requirement of the DUT or a table that lists specific parameters associated with the DUT and their corresponding values. Such an approach can allow for a more accurate and relevant extraction of structured requirements from the documentation as compared to traditional chunking methods.

At 406, semantic units and/or chunks can be collected as output of the partitioning process 404.

At 408, a structured LLM call, e.g., based on the system prompt for the entity extraction task derived at 400 can be issued against each semantic unit or chunk output at 406 in parallel, e.g., to ensure relevant source location metadata is maintained. The structured LLM call can be to an LLM such LLM 304. In some instances, the structured LLM call can be to the LLM via an API, such as API 302. The resulting extracted requirements are combined into a single collection and output at 410.

At 412, the output 410 can be inputted into a de-duplication process. In general, a library (e.g., such as Pydantic), which allows specification of validation rules (e.g., a validation model) for objects generated by the LLM can be used as part of de-duplication/validation. For example, after the LLM generates the object string (e.g., output at 410), the object string can be parsed using the validation model to ensure that the LLM responses (e.g., output 410) conform to the object expectations/requirements (e.g., as defined at 400).

In some instances, a vector embedding for a string serialized version of each requirement entity (e.g., output of the structured LLM call) can be generated. In some instances, to improve an effectiveness and/or semantic richness of the vector embeddings on the modeled objects, a preprocessing step can skips details about the structured object (e.g., such as field names) and focus on actual values and attributes. In addition, domain-specific transformations on attributes can be performed to further enrich data used to generate a vector embedding. Note that the domain-specific transformations on the attributes can allow the process to find and compare similar structured objects more effectively based on their data content rather than their structure.

Further, in some instances, a filter can be applied to the vector embeddings generated from the output of the structured LLM call. For example, requirement entities whose vector embeddings have a similarity score with another requirement entity that exceeds a threshold value (e.g., such as a 0.90, 0.95, and/or 0.99 similarity score or higher) can be filtered out such that if and/or when multiple requirements are remarkably similar (e.g., have similarity scores exceed the threshold value), these multiple requirements can be reduced to a single requirement. In some instances, a Cosine similarity can be used as a similarity criterion.

Additionally, in some instances, each requirement entity can be assigned to a cluster or group. For example, Uniform Manifold Approximation and Projection (UMAP) can be used a preprocessing step to boost performance of density-based clustering, e.g., to reduce a dimensionality of existing high dimensionality vector embeddings. Then a hierarchical cluster algorithm, e.g., such as Hierarchical Density-Based Spatial Clustering of Applications with Noise (HDBSCAN), can be used to assign each requirement to clusters of similar requirements. Note that the cluster label can be held (or stored) in a requirement's metadata object.

In some instances, a “best” representative requirement entity from a cluster can be chosen and remaining requirement entities in the cluster can be filtered out (e.g., removed). The remaining requirement entity can be considered as a closest to a centroid of the identified cluster of vector embeddings and thus represents the group of similar requirement entities the “best”. In some instances, to reduce the requirement entities in a cluster of similar requirements into a more consolidated collection of requirements a structured LLM call (e.g., called in parallel) can be used. In such instances, LLM input text (e.g., prompt) can specify a task of refining/de-deduplicating requirement entities in the cluster such that a resulting output is a minimal set of requirement entities that capture all the pertinent (or important/relevant) information. Note that the same object model output instructions can be used and an entire group of requirement entities in a single cluster can be provided in each parallel call.

Note that when an object string fails validation when parsing from the object string to the validation model, a specific LLM generation with the same system prompt can be retried until success (e.g., validation) or until a maximum amount of generation attempts has been reached (e.g., a number of generation attempts/retries exceeds a threshold). In such instances, a failure can be logged along with a recording of the offending (e.g., failed) semantic unit from the documentation as well as the prompt resulting in the unsuccessful generation. This can then be reviewed by a human in the loop and allow intervention in cases where the automatic process failed.

At 414, upon validation, a collection of requirement entities which capture pertinent information from the specification documentation has been generated to form test requirements for the DUT. Additionally, the human in the loop can be presented with all chunks from the documentation against which the LLM was unable to successfully generate valid requirement entities (e.g., which can occur on more complex extraction tasks and presents an opportunity for the human to intervene and finish the requirements specification). In some instances, e.g., such as when a structured object is compatible with an API, an API upload can be called to upload the test requirements for the DUT to a test system.

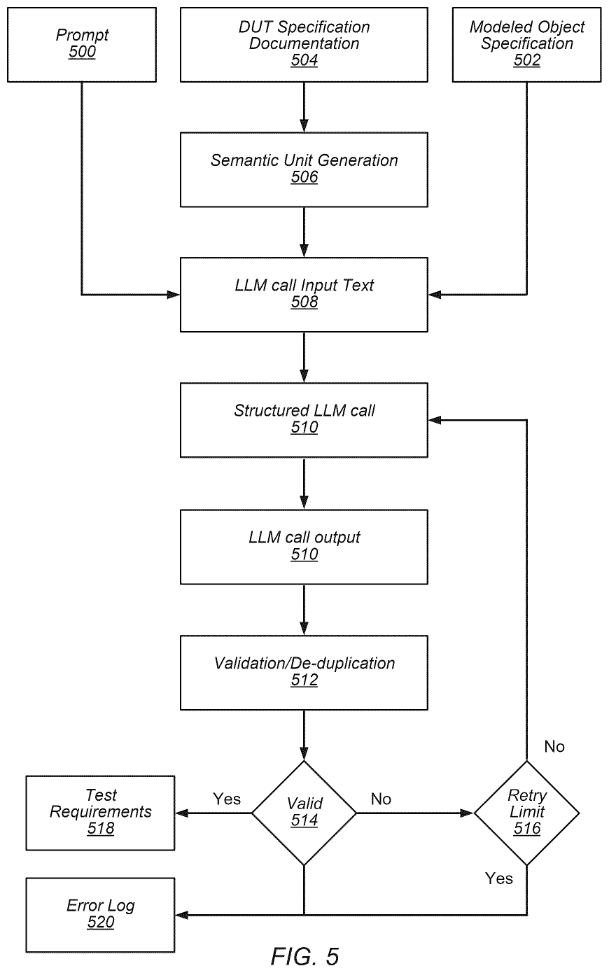

FIG. 5 illustrates a block diagram of another example of a process for extracting structured specification requirements (e.g., structured object/object model) from specification documents associated with a DUT, according to some embodiments. The process shown in FIG. 5 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 500, a system prompt for an entity extraction task (e.g., the entity extraction task can be a structured object such as test requirements) can be received. In some instances, construction of the system prompt for the entity extraction task can include English instructions that provide initial instructions, guidelines in the entity extraction task, and/or definition of an object model/structured object that captures a structure and content of an object (e.g., object model) to be extracted (e.g., test requirements for the DUT). Note that schema that defines the structure and content of the object model can be used as output formatting instructions in a subsequent call to an LLM, such as LLM 304.

At 502, a modeled object specification, e.g., of the test requirements, can be loaded and/or retrieved from and/or via an API, such as API 302. The modeled object specification can include a definition of output of the process, e.g., a definition of the test requirements. In some instances, the output modeled objects can be associated with a class, e.g., such as “typical specification” or “operating range”, among other classes.

At 504, specification requirements documentation associated with a DUT can be loaded into memory. This documentation can take various forms, including, but not limited to, word processing documents, Portable Document Format (PDF) documents, spreadsheets, presentation documents, three-dimensional (3D) models, two-dimensional (2D) models, images, videos, and/or other multimedia recordings, among other file types and/or formats.

At 506, the specification requirements documentation (e.g., documentation), modeled object specification, and/or the entity extraction task can be combined into input text for an LLM (e.g., LLM call input text). Note that the documentation can be partitioned into various smaller semantic units that together encompass the specification requirements documents (e.g., via chunking). Note that such partitioning can extend beyond typical chunking methods as the partitioning collects and groups plaintext, tabular data, as well as various media (graphs, diagrams, images, videos, and the like) modalities into their respective semantic units (chunks). These respective semantic units can capture one or more whole elements to preserve coherence and completeness of concepts in the specification requirements documentation. In addition, metadata that captures information about the source and location of elements in a semantic unit can be recorded. Further, the semantics-based chunking described herein allows the specification requirements documentation to be partitioned into meaningful units that are relevant to the context and meaning of the text. For example, a chunk (and/or sematic unit) can be a paragraph that describes a specific feature or requirement of the DUT or a table that lists specific parameters associated with the DUT and their corresponding values. Such an approach can allow for a more accurate and relevant extraction of structured requirements from the documentation as compared to traditional chunking methods.

At 508, a structured LLM call, e.g., based on the LLM call input text, can be issued. The structured LLM call can be to an LLM such LLM 304. In some instances, the structured LLM call can be to the LLM via an API, such as API 302. The resulting extracted requirements are combined into a single collection and as LLM call output at 510.

At 512, the LLM call output 510 can be inputted into a de-duplication process. In general, a library (e.g., such as Pydantic), which allows specification of validation rules (e.g., a validation model) for objects generated by the LLM can be used as part of de-duplication/validation. For example, after the LLM generates the object string (e.g., output at 510), the object string can be parsed using the validation model to ensure that the LLM responses (e.g., output 510) conform to the object expectations/requirements (e.g., as defined at 500).

In some instances, a vector embedding for a string serialized version of each requirement entity (e.g., output of the structured LLM call) can be generated. In some instances, to improve an effectiveness and/or semantic richness of the vector embeddings on the modeled objects, a preprocessing step can skip details about the structured object (e.g., such as field names) and focus on actual values and attributes. In addition, domain-specific transformations on attributes can be performed to further enrich data used to generate a vector embedding. Note that the domain-specific transformations on the attributes can allow the process to find and compare similar structured objects more effectively based on their data content rather than their structure.

Further, in some instances, a filter can be applied to the vector embeddings generated from the output of the structured LLM call. For example, requirement entities whose vector embeddings have a similarity score with another requirement entity that exceeds a threshold value (e.g., such as a 0.90, 0.95, and/or 0.99 similarity score or higher) can be filtered out such that if and/or when multiple requirements are remarkably similar (e.g., have similarity scores exceed the threshold value), these multiple requirements can be reduced to a single requirement. In some instances, a Cosine similarity can be used as a similarity criterion.

Additionally, in some instances, each requirement entity can be assigned to a cluster or group. For example, Uniform Manifold Approximation and Projection (UMAP) can be used a preprocessing step to boost performance of density-based clustering, e.g., to reduce a dimensionality of existing high dimensionality vector embeddings. Then a hierarchical cluster algorithm, e.g., such as Hierarchical Density-Based Spatial Clustering of Applications with Noise (HDBSCAN), can be used to assign each requirement to clusters of similar requirements. Note that the cluster label can be held (or stored) in a requirement's metadata object.

In some instances, a “best” representative requirement entity from a cluster can be chosen and remaining requirement entities in the cluster can be filtered out (e.g., removed). The remaining requirement entity can be considered as a closest to a centroid of the identified cluster of vector embeddings and thus represents the group of similar requirement entities the “best”. In some instances, to reduce the requirement entities in a cluster of similar requirements into a more consolidated collection of requirements a structured LLM call (e.g., called in parallel) can be used. In such instances, LLM input text (e.g., prompt) can specify a task of refining/de-deduplicating requirement entities in the cluster such that a resulting output is a minimal set of requirement entities that capture all the pertinent (or important/relevant) information. Note that the same object model output instructions can be used and an entire group of requirement entities in a single cluster can be provided in each parallel call.

At 514, a determination of the validity of the object string can be made. When the object string is determined to be valid, the process can continue at 518. When the object string is determined to be invalid (or not valid), the process can continue at 516.

At 516, in response to determining that the object string is not valid at 514, a number of retries can be compared to a threshold (e.g., a retry or failure threshold). In response to determining that the number of retries is less than the threshold, the process can return to structured LLM call 510. In response to determining that the number of retries exceeds the threshold, the process can continue at 520.

At 518, upon validation, a collection of requirement entities which capture pertinent information from the specification documentation has been generated to form test requirements for the DUT. Additionally, the human in the loop can be presented with all chunks from the documentation against which the LLM was unable to successfully generate valid requirement entities (e.g., which can occur on more complex extraction tasks and presents an opportunity for the human to intervene and finish the requirements specification). In some instances, e.g., such as when a structured object is compatible with an API, an API upload can be called to upload the test requirements for the DUT to a test system.

At 520, upon determining a failure of an object string, a failure can be logged along with a recording of the offending (e.g., failed) semantic unit from the documentation as well as the prompt resulting in the unsuccessful generation. This can then be reviewed by a human in the loop and allow intervention in cases where the automatic process failed.

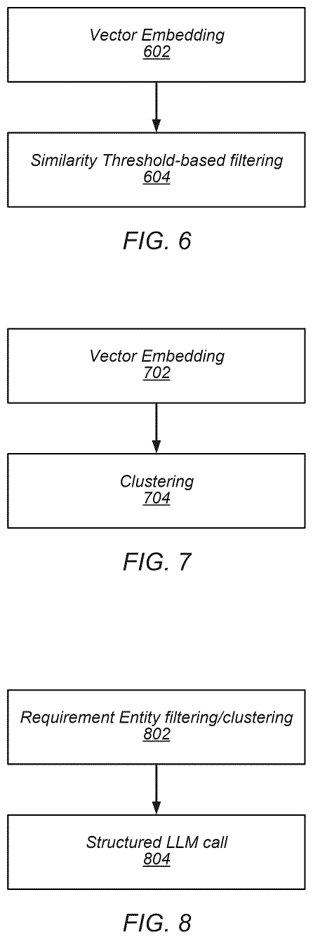

FIG. 6 illustrates a block diagram of an example of a process for filtering requirement entities outputted from a structured LLM call, according to some embodiments. The process shown in FIG. 6 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 602, a vector embedding for a string serialized version of each requirement entity output from a structured LLM call can be generated. In some instances, to improve an effectiveness and/or semantic richness of the vector embeddings on the modeled objects, a preprocessing step can skip details about the structured object (e.g., such as field names) and focus on actual values and attributes. In addition, domain-specific transformations on attributes can be performed to further enrich data used to generate a vector embedding. Note that the domain-specific transformations on the attributes can allow the process to find and compare similar structured objects more effectively based on their data content rather than their structure.

At 604, a similarity threshold-based filter can be applied to the vector embeddings. For example, requirement entities whose vector embeddings have a similarity score with another requirement entity that exceeds a threshold value (e.g., such as a 0.90, 0.95, and/or 0.99 similarity score or higher) can be filtered out such that if and/or when multiple requirements are remarkably similar (e.g., have similarity scores exceed the threshold value), these multiple requirements can be reduced to a single requirement. In some instances, a Cosine similarity can be used as a similarity criterion.

FIG. 7 illustrates a block diagram of an example of a process for clustering requirement entities outputted from a structured LLM call, according to some embodiments. The process shown in FIG. 7 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 702, a vector embedding for a string serialized version of each requirement entity output from a structured LLM call can be generated. In some instances, to improve an effectiveness and/or semantic richness of the vector embeddings on the modeled objects, a preprocessing step can skip details about the structured object (e.g., such as field names) and focus on actual values and attributes. In addition, domain-specific transformations on attributes can be performed to further enrich data used to generate a vector embedding. Note that the domain-specific transformations on the attributes can allow the process to find and compare similar structured objects more effectively based on their data content rather than their structure.

At 704, a clustering process can be applied to the embeddings. For example, Uniform Manifold Approximation and Projection (UMAP) can be used a preprocessing step to boost performance of density-based clustering, e.g., to reduce a dimensionality of existing high dimensionality vector embeddings. Then a hierarchical cluster algorithm, e.g., such as Hierarchical Density-Based Spatial Clustering of Applications with Noise (HDBSCAN), can be used to assign each requirement to clusters of similar requirements. Note that the cluster label can be held (or stored) in a requirement's metadata object.

In some instances, a “best” representative requirement entity from a cluster can be chosen and remaining requirement entities in the cluster can be filtered out (e.g., removed). The remaining requirement entity can be considered as a closest to a centroid of the identified cluster of vector embeddings and thus represents the group of similar requirement entities the “best”.

In some instances, to reduce the requirement entities in a cluster of similar requirements into a more consolidated collection of requirements a structured LLM call (e.g., called in parallel) can be used. In such instances, LLM input text (e.g., prompt) can specify a task of refining/de-deduplicating requirement entities in the cluster such that a resulting output is a minimal set of requirement entities that capture all the pertinent (or important/relevant) information. Note that the same object model output instructions can be used and an entire group of requirement entities in a single cluster can be provided in each parallel call.

FIG. 8 illustrates a block diagram of an example of a process for consolidating clusters of similar requirement entities outputted from a structured LLM call, according to some embodiments. The process shown in FIG. 8 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 802, requirement entities outputted from a structured LLM can be filtered or clustered into clusters of similar requirement entities, e.g., as described above in reference to FIG. 6 and/or FIG. 7.

At 804, a structured LLM call (e.g., called in parallel) can be used. In such instances, LLM input text (e.g., prompt) can specify a task of refining/de-deduplicating requirement entities in the cluster such that a resulting output is a minimal set of requirement entities that capture all the pertinent (or important/relevant) information. Note that the same object model output instructions can be used and an entire group of requirement entities in a single cluster can be provided in each parallel call.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for extracting structured specification requirements from specification documents associated with a device under test (DUT), comprising:
generating one or more semantic units based on DUT specification documentation; and
performing a structured large language model (LLM) call to generate test requirements for the DUT based on the generated one or more semantic units and an entity extraction task.

2. The method of claim 1, further comprising:
receiving, via a user interface (UI), a system prompt command for the entity extraction task.

3. The method of claim 2,
wherein the system prompt command is received responsive to presenting an end user with a system prompt for the entity extraction task.

4. The method of claim 3,
wherein the system prompt includes one or more of:
English instructions that provide initial instructions;
guidelines; or
definition of an object model/structured object that captures a structure and content of an object to be extracted.

5. The method of claim 1,
wherein the entity extraction task comprises a structured object.

6. The method of claim 1,
wherein the DUT specification documentation includes one or more of:
word processing documents;
Portable Document Format (PDF) documents;
spreadsheets;
presentation documents;
three-dimensional (3D) models;
two-dimensional (2D) models;
images; or
videos.

7. The method of claim 1,
wherein generating the one or more semantic units based on DUT specification documentation comprises partitioning the DUT specification documentation into the one or more semantic units.

8. The method of claim 7,
wherein the partitioning includes collecting and grouping plaintext, tabular data, graphs, diagrams, images, and/or videos modalities into respective semantic units.

9. The method of claim 8,
wherein respective semantic units capture one or more whole elements to preserve coherence and completeness of concepts in the DUT specification documentation.

10. The method of claim 8,
wherein the partitioning further includes recording metadata that captures information about a source and a location of elements in a respective semantic unit.

11. A non-transitory computer-readable memory medium storing program instructions which, when executed by a processor, are configured to cause a computing device to perform operations comprising:
generating one or more semantic units based on DUT specification documentation; and
performing a structured large language model (LLM) call to generate test requirements for the DUT based on the generated one or more semantic units and an entity extraction task.

12. The non-transitory computer readable memory medium of claim 11,
wherein output from the structured LLM call comprises one or more objects; and
wherein the program instructions are further executable by the processor to cause the computing device to perform operations comprising validating the one or more objects outputted from the structured LLM call.

13. The non-transitory computer readable memory medium of claim 12,
wherein validating the one or more objects comprises parsing the one or more objects via a validation model, and
wherein the validation model comprises one or more validation rules.

14. The non-transitory computer readable memory medium of claim 11,
wherein output from the structured LLM call comprises one or more objects; and
wherein the program instructions are further executable by the processor to cause the computing device to perform operations comprising:
determining that one or more objects cannot be validated;
generating an error log comprising the one or more objects; and
providing, via a user interface (UI), the error log to an end user.

15. An apparatus, comprising:
a memory; and
at least one processor in communication with the memory and configured to perform operations comprising:
generating one or more semantic units based on DUT specification documentation; and
performing a structured large language model (LLM) call to generate test requirements for the DUT based on the generated one or more semantic units and an entity extraction task.

16. The apparatus of claim 15,
wherein output from the structured LLM call comprises one or more objects; and
wherein the at least one processor is further configured to perform operations comprising:
generating, for each of the one or more objects, a vector embedding for a string serialized version of a respective object; and
applying a similarity threshold-based filter to the generated vector embeddings.

17. The apparatus of claim 16,
wherein applying the similarity threshold-based filter includes consolidating objects of the one or more objects that have a similarity score greater than a threshold value; and
wherein the at least one processor is further configured to perform operations comprising performing clustering on the one or more objects.

18. The apparatus of claim 17,
wherein performing the clustering of the one or more objects includes reducing a dimensionality of existing high dimensionality vector embeddings; and
assigning objects of similar requirements to clusters of similar requirements via a hierarchical cluster algorithm.

19. The apparatus of claim 16,
wherein the at least one processor is further configured to perform operations comprising:
reducing the one or more objects to clusters of similar objects; and
performing a structured LLM call to generate a minimal set of objects.

20. The apparatus of claim 16,
wherein the at least one processor is further configured to perform operations comprising:
uploading the one or more objects to an Application Programming Interface (API).
